(19) United States
(12) Patent Application Publication
(10) Pub. No.: US 2005/0254925 A1
(43) Pub. Date: Nov. 17, 2005

(54) Lift apparatus for an all-terrain vehicle

(76) Inventor: Larry Braquet, New Iberia, LA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 10/845,399

(22) Filed: May 13, 2004

(51) Int. Cl. B60P 9/00

(52) U.S. Cl. 414/462

(57) ABSTRACT

A lift assembly for use with an all-terrain vehicle has a mount assembly attachable to the ATV, a platform and a pivot assembly moving the platform from a loading position close to the ground, to an elevated position above or close to the level of a cargo rack of the ATV. The lift assembly may be used for lifting bales of hay, bags of seeds, carcasses of animals and other heavy cargo to a pre-determined distance above the ground. The pivot assembly, while pivoting along a vertical plane, retains the platform in a horizontal orientation, thus facilitating stable position of the lifted objects on the platform.

### BACKGROUND OF THE INVENTION

The present invention relates to a lift assembly, and more particularly to a lift assembly for detachable engagement with an all-terrain vehicle, such as a four-wheeler used for transporting people and heavy objects around irregular terrain.

The use of lift and load assemblies is well known in the prior art. Many farmers use all terrain vehicles for transporting bales of hay, bags with seeds and similar heavy bulky loads around the farm. The all terrain vehicles are also widely used by hunters to travel to and from the hunting sites and transport a game animal carcass from the hunting site to a cabin, truck, or other location. For many hunters, lifting of a heavy animal becomes problematic especially if the cargo area of a conventional small vehicle is elevated 2 or 3 feet above the ground. In many cases, lifting of the dead animal to the rack of the ATV requires two or more people working with a heavy unyielding load.

Many solutions have been offered in the industry to solve the problem. For instance, the industry is aware of hoisting mechanisms which are attached to the ATVs and that can be used for moving the heavy load from the ground up. However, in many cases, hoisting of a dead animal is impossible unless the animal is first loaded onto some type of platform or tied to a harness.

The present invention contemplates elimination of drawbacks associated with the prior art and provision of a lift assembly with a horizontal platform that can be lowered to the ground level and then lifted to above the rack level of a standard all-terrain vehicle.

### SUMMARY OF THE INVENTION

It is, therefore, an object of the present invention to provide a lift assembly for elevating the cargo from the ground to a predetermined distance above the ground.

It is another object of the present invention to provide a lift assembly for lifting cargo that can be secured to a small vehicle, such as an all terrain vehicle.

It is a further object of the present invention to provide a lift assembly for lifting cargo from the ground level that can be operated by a winch or other readily available lifting power source.

These and other objects of the present invention are achieved through a provision of a lifting apparatus that has a mount assembly for detachable engagement with the all-terrain vehicle. The mount assembly extends vertically, with its upper end secure to the ATV and its lower end carrying a pivot assembly. The pivot assembly is comprised of a pair of parallel arm units, each arm unit made of an upper arm and a lower arm. The upper and lower arms are pivotally connected to each by brackets secured to the arms by pivot pins.

The lower arms of the opposing arm units connect to a platform, which has a configuration of an open frame with longitudinal and cross frame members. A locking assembly extends between the pivot assembly and the platform to secure the platform in a horizontal orientation and to retain the platform in the horizontal orientation during the lifting procedure. When the locking assembly is disengaged from the platform, the platform pivots against hinges and folds to a substantially vertical orientation for storage.

The lifting power may be provided by a winch or by an electric power source, such as a DC battery. If the apparatus is equipped with a winch connection, the winch cable extends from the spool mounted on the ATV to a cross bar secured to the mount assembly. A pulley is attached to a cross brace member of the pivot assembly and guides tensioning of the cable when the winch is operated.

When the platform is in its lowermost position, it rests on the ground. When the platform is at its highest position, the level of the platform frame is at about the level of the ATV rack or slightly above that level. The operator can easily load the object on the platform from the ground and elevate the object to a desired height. The load can then be easily pushed onto the ATV rack and transported to a certain distance from the load site.

### BRIEF DESCRIPTION OF THE DRAWINGS

Reference will now be made to the drawings, wherein like parts are designated by like numerals, and wherein

FIG. 1 is a perspective view of the lift assembly, with a platform in its lowermost position.

FIG. 2 is a perspective view of the lift assembly, with the platform in a mid-elevated position.

FIG. 3 is a side view of the lift assembly of the present invention showing movement of the lift assembly from the downward to the upward position and a folded view of the lift apparatus.

FIG. 3A illustrates a folded position of the lift apparatus of the present invention.

FIG. 4 is a detail view showing the mount assembly of the lift apparatus.

FIG. 5 is a detail side view of the mount assembly.

FIG. 6 is a detail view showing the platform for use in the lift assembly of the present invention.

FIG. 7 is a detail side view of the platform shown in FIG. 6.

FIG. 8 is a detail view of the latch unit securing the platform to the pivot assembly.

FIG. 9 a detail front view of a lower pivot bracket

FIG. 10 is a detail view of the pulley for use with the lift aapparatus of the present invention.

### DETAILED DESCRIPTION OF THE PREFERREED EMBODIMENT

Turning now to the drawings in more detail, numeral 10 designates the lift apparatus in accordance with the present invention. As can be seen in the drawings, the lift apparatus, or assembly 10 comprises a mount assembly 12, a pivot assembly 14, and a load platform 16. The mount assembly 12 is adapted for attachment to a rack 18 of a vehicle 20, which may be an all terrain vehicle. The rack 18 is a standard accessory for the vehicle 20 and does not form a part of the present invention.

The mount assembly 12 comprises an A-frame comprised of a pair of elongate converging frame members 32, 34, which have a cross plate 36 secured to the top portions thereof. The cross plate 36 extends transversely to longitudinal axis of the frame members 32 and 34. A central opening 38 is formed through the cross plate 36 for receiving an securing element (not shown), for instance a locking pin or a bolt for attaching the cross plate 36 to the rack 18.

Extending between the frame members 32 and 34, below the cross member 36 is a second cross member 40, to which one end of a flexible cable 42 is secured. The mount frame 12 extends substantially vertically in a transverse relationship to the rack 18 of the vehicle 20.

The pivot frame 14 comprises a pair of elongated parallel double arm units 44 and 46. Each double arm 44 and 46 comprises a lower arm 44a, 46a and an upper arm 44b, 46b, which are retained in a parallel relationship to each other by pivot brackets. Upper ends of the elongated arms 44a, 44b are secured to a pivot bracket 50. The upper ends of the elongated 46a and 46b are secured to a pivot bracket 52. A pivot pin 54 extends through an opening 56 of the bracket 50. A second pivot pin 58 extends through an opening 60 of the bracket 50. The pivot pin 54 secures the arm 44b to the bracket 50. The pivot pin 58 secures the upper end of the arm 44a to the bracket 50. A pivot pin 62 extends through an opening 64 of the bracket 52 and secures the arm 46b to the bracket 52. A pivot pin 66 extends through an opening 68 of the bracket 52 and secures the upper end of the arm 46a to the bracket 52.

Lower ends of the arms 44a, 44b, 46a, and 46b are similarly provided with pivot brackets 70 and 72 respectively. As can be seen in the drawings, the bracket 70 is secured to the arms 44a and 44b through pivot pins 76 and 74, respectively. The opposite bracket 72 is similarly secured to the elongated arms 46a and 46b to respective pivot pins 78 and 80. The brackets 50, 52, 70 and 72 allow a limited pivotal movement of the arms 44a, 44b, 46a, 46b about pivot axes defined by the pivot pins.

Secured between the brackets 50 and 52 is a cross brace member 90 which is fixedly mounted to the brackets 50 and 52. The cross brace 90 retains the brackets 52 and 50 in a spaced parallel relationship to each other.

A cable guiding bracket 92 is positioned above the cross brace 90. The guiding bracket 92 comprises a pair of attachment plates 94, 96 which are secured to the A-frame members 32, 34 and rest on top of the cross brace 90. A guiding rod 98 is fitted between the attachment members 94 and 96 and guides the cable 42 towards a pulley 100, which is secured through a mounting member 102 to a second cross brace member 104 extending between the lower arms 44a and 46a. The pulley 100 and its mounting member 102 are secured by bolt 106 or similar attachment members to the second cross brace 104.

A third cross brace member 110 is mounted between the brackets 70 and 72, adjacent to the lower portions of the arms 44a, 44b, 46a, and 46b. The third cross brace member 110, similar to the cross brace 90 is fixedly secured to the pivot plates 70 and 72. The cross brace member 110, similarly to the first cross brace 90 and the second cross brace 104 facilitates retaining of the arms 44a, 44b, 46 and 46b in a parallel relationship to each other during operation of the apparatus 10.

The platform 16 comprises an open frame having a frame member 112, which defines the outer periphery of the load-bearing platform 16. A pair of cross frame members 114 and 116 extends in a transverse relationship to the longitudinal axis of the frame 112. A retaining bar 118 extends between the center of shorter end 122 of the frame 112 to a center of the cross frame member 114 and is fixedly engaged therewith. A corresponding opposite bar 120 extends from the opposite parallel shorter end 124 of the frame 112 to a mid-section of the cross member 116 and is fixedly attached thereto.

A locking latch assembly 130 is mounted between the third cross brace member 110 and the platform 16. The latch assembly 130 comprises a cross brace 132 secured between the transverse brace members 114 and 116, a latch member 134, and associated mounting units. The first mounting unit for the latch assembly 130 comprises a pair of attachment brackets 134 and 136 attached to the third cross brace member 110. A pivot pin 138 extends through aligned openings 140 formed in the brackets 134 and 136. A first end of the latch member 134 forms a sleeve 142, which engages the pin 138 in a free pivotal engagement.

A second end 144 of the latch assembly 130 has a hook-shaped member 146, which is configured to detachably engage a U-shaped bracket 148 secured to the brace 132 through an attachment plate 150. The latch assembly 130 retains the platform 16 in a horizontal position when engaged with the bracket 148. Consequently, an object positioned on the platform 16 can be lifted substantially horizontally, without falling out from the lift apparatus 10.

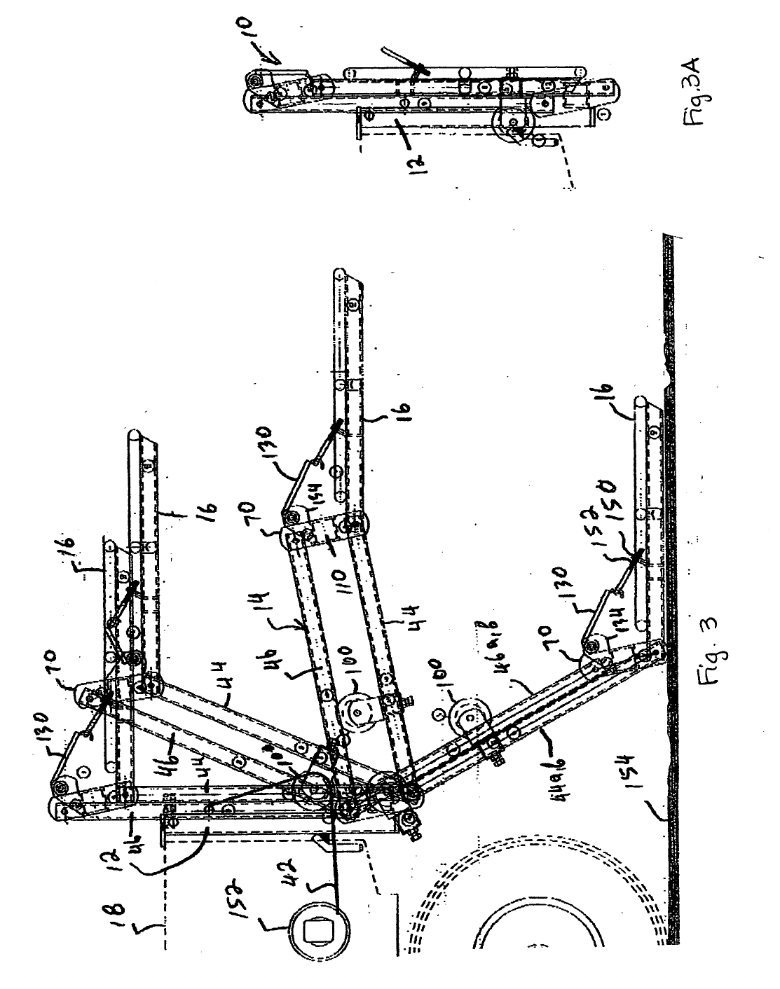

When the hook 148 is released from its engagement with the bracket 148, the platform may be folded for storage together with the pivot assembly 14. FIG. 3A illustrates the folded view of the apparatus 10 of the present invention. As can be seen in the drawing, the apparatus 10 extends in a substantially vertical position when folded against the mount frame 12.

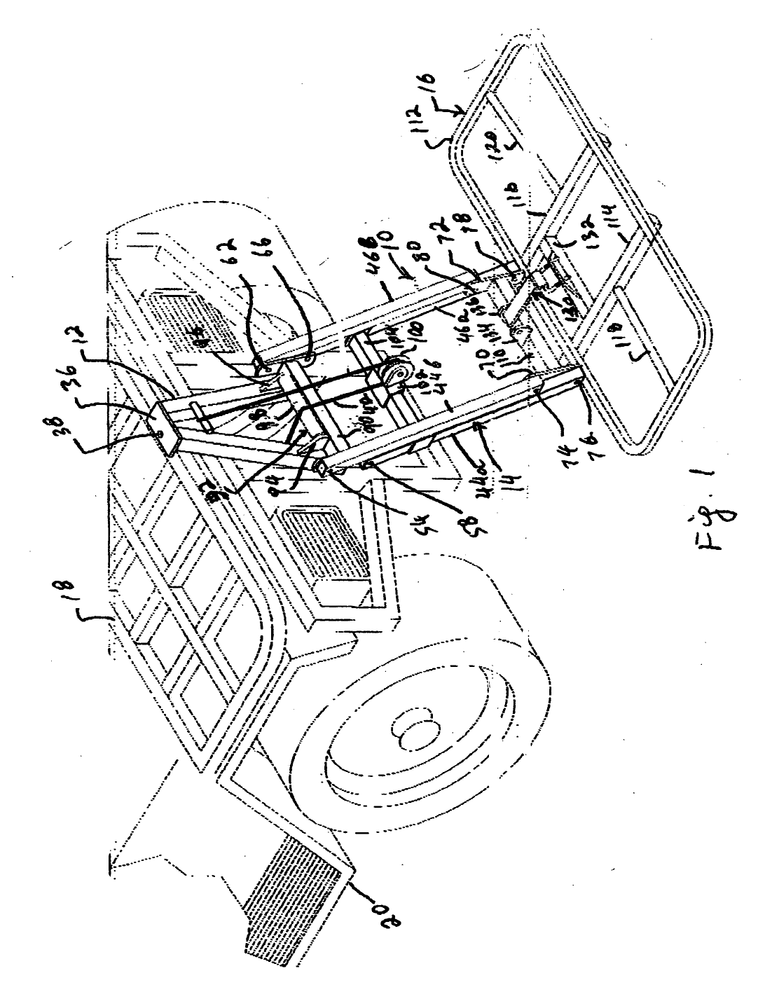

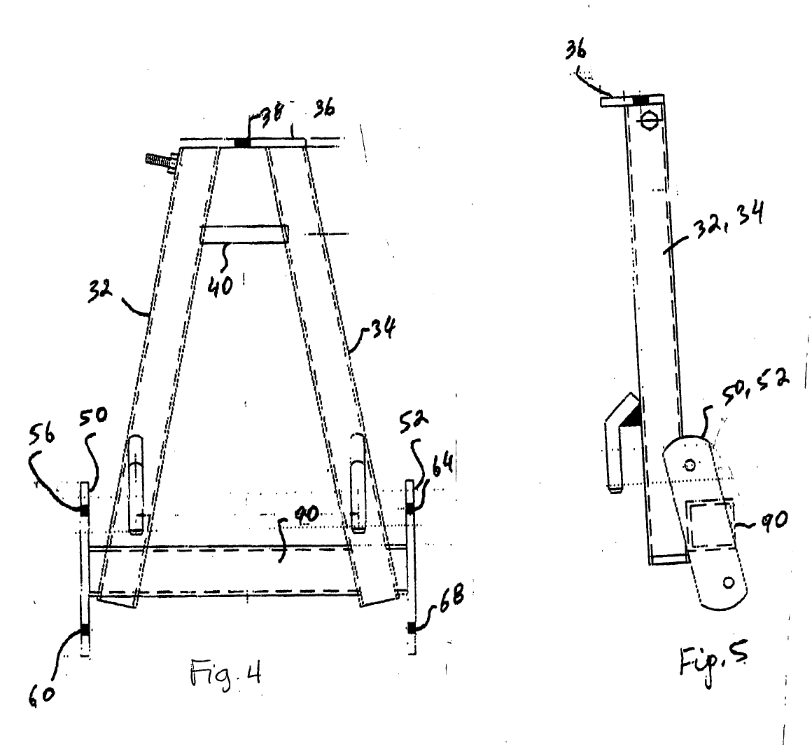

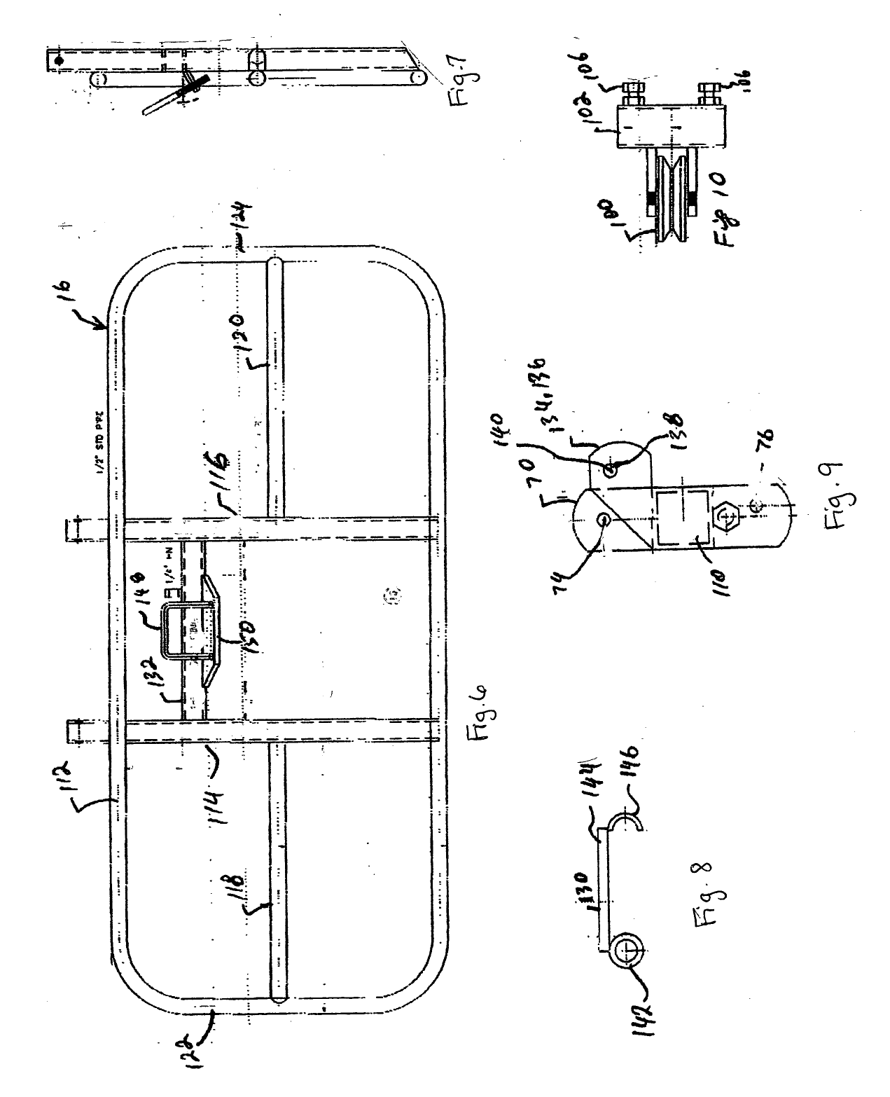

In the embodiment of FIGS. 1-10, the lift assembly is activated by a conventional winch 152 provided on the vehicle 20. Other means of moving the lift assembly can be provided, for instance, electric motor, battery, and the like.

In operation, a user operates the winch 152 to lower the platform 16 to the ground level 154. At that time, the platform 16 rests on the ground 154 and the unit arms 44a, 44b, 46a and 46b extend at an obtuse angle to the platform 16. The latch assembly 130 retains a predetermined angular relationship between the pivot assembly 14 and the platform 16. The pivot arms 44a, 44b and 46a, 46b are in close proximity to each other while being retained in a parallel relationship through the pivotal engagement between the pivot arms and the pivot brackets.

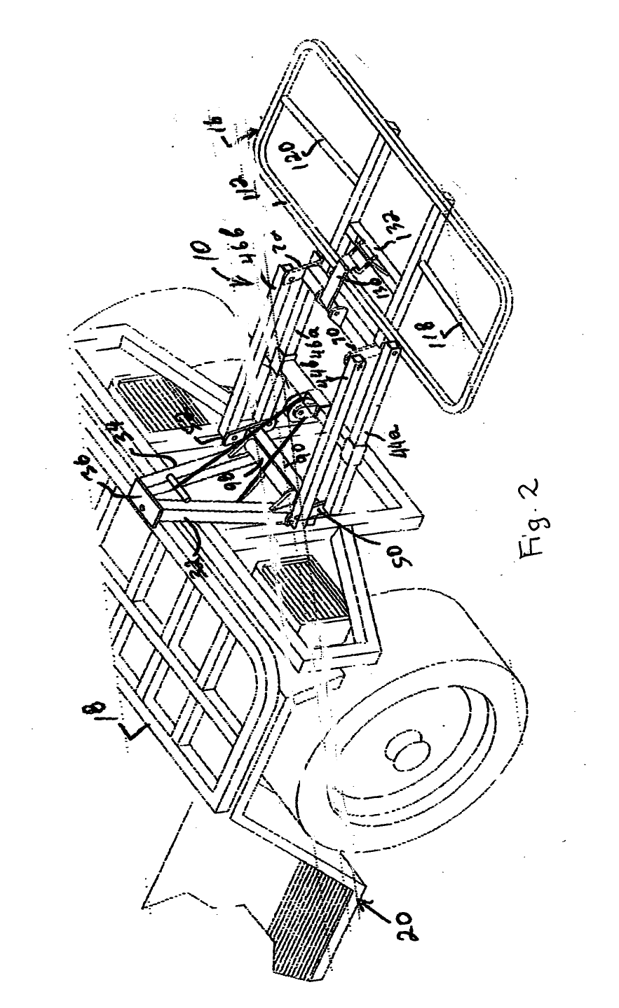

As the cable 42 is tightened, it pulls on the pulley 100 which causes the pivot assembly 14 to move upwardly, pulling the platform 16 with the object loaded thereon higher from the ground level 154. A mid-elevated position of the lift apparatus 10 can be also seen in FIG. 2. In that position, the platform 16 remains in a horizontal position, substantially parallel to the ground level 154, while the pivot assembly 14 pivots, spreading the pivot arm units 44 and 46 to some distance from each other. The latch unit 130 continues to fully secure the position of the platform 16 in relation to the brackets 134 and 136.

As the platform 16 is raised higher, under the force of the wound cable 42, the pivot arms 44a, 44b, 46a, and 46b continue pivoting against their respective brackets 50, 52, 70, 72. In the uppermost position, the pivot arms 44, 46 extend substantially vertically with a small space between the parallel arms 44a, 44b and 46a, 46b. The latch assembly 130 continues retaining of the platform 16 in a horizontal orientation.

When the platform reaches its highest position, it is oriented at a level substantially equal to or somewhat higher than the rack 18. At that time, the operator transfers the load of the platform 16 onto the rack 18 of the vehicle 20, transferring the cargo from the lift assembly 10 to the vehicle 20. Once the load has been transferred, the operator may either return the lift assembly 10 to its load-ready position, with the platform 16 on the ground or fold the lift apparatus 10 to a storage position. In the storage position, shown in FIG. 3A, the mount assembly 12, the pivot assembly 14, and the platform 16 are oriented substantially vertically, such that the platform 16 extends substantially parallel to the pivot assembly 14 and to the mount assembly 12. The compact storage position of the lift apparatus 10 provides an additional advantage in comparison with hoisting and similar types of lifting mechanisms used for lifting the cargo to the vehicle racks.

When additional loads need to be picked up at the same site or at another location, the winch 152 is again operated, unwinding the cable 42 and allowing the arms 44 and 46 to pivot and lower the platform 16 to the ground. The latch assembly 130 is again reengaged retaining the platform 16 in a substantially horizontal position while the lifting procedure is conducted by pulling on the cable 42 and pivoting the pivotal arm units 44 and 46.

If desired, the latch assembly 130 may be provided with a tension spring to allow flexibility in folding of the platform 16 and extending the platform 16 to a desired loading and unloading position.

The lift assembly 10 of the present invention may be used to transporting irregular cargo, bags of seeds, boxes, as well as animal carcasses, if necessary. The lift assembly 10 presents an easy to use and inexpensive means of assisting farmers, hunters, and the general population in transporting heavy cargo for short distances.

Many changes and modifications may be made in the design of the present invention without departing from the spirit thereof. I, therefore, pray that my rights to the present invention be limited only by the scope of the appended claims.

1. A lift apparatus for use with an all-terrain vehicle having a load carrying rack, the lift assembly comprising:
a mount assembly being adapted to be securely attached to the all-terrain vehicle;
a pivot assembly having a proximate end secured to a lower end of the mount assembly in a hinged engagement with the mount assembly; and
a platform secured to a distant end of the pivot assembly for supporting objects being lifted, said platform retaining a substantially horizontal orientation during the lifting procedure.

2. The apparatus of claim 1, wherein said platform is positioned at a vertical level above the rack of said all-terrain vehicle when the platform is elevated to its highest level.

3. The apparatus of claim 1, further comprising a means for transmitting a lifting force to said platform from an external power means.

4. The apparatus of claim 3, wherein said means for transmitting the lifting force comprises a flexible cable positioned between the mount assembly and an external power source.

5. The apparatus of claim 4, wherein said mount assembly comprises an A-shaped frame having elongate converging side frame members, a plate for securing to the all-terrain vehicle attached to upper ends of said converging side frame members, and a cross bar fixedly attached below said plate between said converging frame members.

6. The apparatus of claim 5, wherein a free end of said flexible cable is securely detachably engaged with said cross bar.

7. The apparatus of claim 4, wherein said pivot assembly comprises at least one cross brace member, and wherein said at least one cross brace member is adapted for receiving a lifting force supplied by said external power means.

8. The apparatus of claim 7, wherein said at least one cross brace member carries a pulley for rotationally engaging said flexible cable and transmitting the lifting force to said platform.

9. The apparatus of claim 7, wherein said pivot assembly comprises a pair of elongate parallel arm units retained in a parallel relationship to each other and secured at their free ends to said platform.

10. The apparatus of claim 9, wherein each of said arm units comprises an upper arm and a lower arm pivotally connected to each other by a pair of pivot pins engaged within a pivot bracket.

11. The apparatus of claim 10, wherein said at least one cross brace member extends between lower arms of said arm units.

12. The apparatus of claim 10, wherein said platform is secured to the lower arms of the arm units.

13. The apparatus of claim 1, wherein said mount assembly is retained in a substantially vertical orientation when secured to said all-terrain vehicle.

14. The apparatus of claim 13, wherein said pivot assembly is movable between load lifting positions at an angle to the mount assembly and a substantially vertical storage position.

15. The apparatus of claim 1, wherein said platform is adapted for movement between a substantially horizontal position during a load lifting procedure and a substantially vertical storage position.

16. The apparatus of claim 15, further comprising a latch assembly for securing said pivot assembly to the platform and for retaining said platform in a pre-determined substantially horizontal orientation during the lifting procedure.

17. The apparatus of claim 16, wherein said latch assembly comprises a locking bar extending between the pivot assembly and the platform, and a securing bracket mounted on said platform for detachably engaging one end of said locking bar.

18. The apparatus of claim 17, wherein said platform is hingedly movable in relation to said pivot assembly to the storage position when said locking bar is disengaged from said platform.

19. The apparatus of claim 3, wherein the external power means is a winch.

20. The apparatus of claim 3, wherein the external power means is an electrically powered power source.

21. A lift apparatus for use with an all-terrain vehicle having a load carrying rack, the lift assembly comprising:
a mount assembly being adapted to be securely attached to the all-terrain vehicle;
a pivot assembly having a proximate end secured to a lower end of the mount assembly in a hinged engagement with the mount assembly, said pivot assembly comprising a pair of arm units retained in a parallel relationship to each other by at least one cross bar, each of said arm unit comprising an upper arm and a lower arm hingedly connected to each other by brackets secured between the upper arm and the lower arm by pivot pins;
a platform secured to a distant end of the lower arms of the arm unit for supporting objects being lifted, said platform retaining a substantially horizontal orientation during the lifting procedure and foldable into a substantially vertical position for storage; and
a means for transmitting a lifting force to said platform from an external power means.

22. The apparatus of claim 21, wherein said pivot assembly elevates said platform to a level above said load carrying rack of the all-terrain vehicle.

23. The apparatus of claim 21, wherein said mount assembly comprises an A-shaped frame having elongate converging side frame members, a plate for securing to the all-terrain vehicle attached to upper ends of said converging side frame members, and a cross bar fixedly attached below said plate between said converging frame members.

24. The apparatus of claim 23, wherein said means for transmitting the lifting force comprises a flexible cable extending from the external power source and secured to the cross bar of the mount assembly.

25. The apparatus of claim 21, wherein said pivot assembly comprises at least one cross brace member, and wherein said at least one cross brace member is adapted for receiving a lifting force supplied by said external power means.

26. The apparatus of claim 25, wherein said at least one cross brace member carries a pulley for rotationally engaging said flexible cable and transmitting the lifting force to said platform.

27. The apparatus of claim 26, wherein said at least one cross brace member extends between lower arms of said arm units.

28. The apparatus of claim 21, wherein said mount assembly is retained in a substantially vertical orientation when secured to said all-terrain vehicle.

29. The apparatus of claim 21, wherein said pivot assembly is movable between load lifting positions at an angle to the mount assembly and a substantially vertical storage position.

30. The apparatus of claim 21, further comprising a latch assembly for securing said pivot assembly to the platform and for retaining said platform in a pre-determined substantially horizontal orientation during the lifting procedure.

31. The apparatus of claim 30, wherein said latch assembly comprises a locking bar extending between the pivot assembly and the platform, and a securing bracket mounted on said platform for detachably engaging one end of said locking bar.

32. The apparatus of claim 31, wherein said platform is hingedly movable in relation to said pivot assembly to the storage position when said locking bar is disengaged from said platform.
